(19) United States
(12) Patent Application Publication
(10) Pub. No.: US 2025/0279948 A1
(43) Pub. Date: Sep. 4, 2025

(54) METHOD AND DEVICE FOR BROADCASTING QOE CONFIGURATION IN WIRELESS COMMUNICATION SYSTEM

(71) Applicant: Samsung Electronics Co., Ltd., Suwon-si, Gyeonggi-do (KR)

(72) Inventors: Seungbeom JEONG, Suwon-si (KR); Sangkyu BAEK, Suwon-si (KR)

(21) Appl. No.: 18/858,164

(22) PCT Filed: Apr. 19, 2023
(86) PCT No.: PCT/KR2023/005314

§ 371 Date: Oct. 18, 2024

(30) Foreign Application Priority Data
Apr. 19, 2022 (KR) 10-2022-0048152

(51) Int. Cl. H04L 43/0876; H04W 76/40

(52) U.S. Cl. CPC H04L 43/0876; H04W 76/40

(57) ABSTRACT

The disclosure relates to a 5G or 6G communication system for supporting a higher data transmission rate. According to various embodiments of the present disclosure, method performed by a terminal in a wireless communication system, the method comprising, receiving, from a base station, a first message including quality of experience (QoE) configuration information, performing a QoE measurement, based on the QoE configuration information, and transmitting, to the base station, a second message including a result of the QoE measurement.

### TECHNICAL FIELD

The disclosure relates to a wireless communication system and, more particularly, to a device and a method for broadcasting a quality of experience (QoE) configuration in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Various embodiments of the disclosure are to provide a device and a method for broadcasting a QoE configuration in a wireless communication system.

The technical subjects pursued in the disclosure may not be limited to the above-mentioned technical subjects, and other technical subjects which are not mentioned may be clearly understood from the following descriptions by those skilled in the art to which the disclosure pertains.

### Solution to Problem

According to various embodiments of the disclosure, an operation method of a terminal in a wireless communication system may include receiving a first message including quality of experience (QoE) configuration information from a base station, performing QoE measurement, based on the QoE configuration information, and transmitting a second message including a QoE measurement result to the base station, wherein the first message may be broadcast from the base station.

According to various embodiments of the disclosure, in a terminal in a wireless communication system, an operation method of a base station in a wireless communication system may include transmitting a first message including quality of experience configuration (QoE) information to a terminal, and receiving a second message including a QoE measurement result from the terminal, wherein the first message may be broadcast, and the QoE measurement may be performed based on the QoE configuration information.

According to various embodiments of the disclosure, a terminal in a wireless communication system may include a transceiver and at least one processor, wherein the at least one processor may be configured to receive a first message including quality of experience (QoE) configuration information from a base station, perform QoE measurement, based on the QoE configuration information, and transmit a second message including a QoE measurement result to the base station, and the first message may be broadcast from the base station.

According to various embodiments of the disclosure, a base station in a wireless communication system may include a transceiver and at least one processor, wherein the at least one processor may be configured to transmit a first message including quality of experience configuration (QoE) information to a terminal, and receive a second message including a QoE measurement result from the terminal, the first message may be broadcast, and the QoE measurement may be performed based on the QoE configuration information.

### Advantageous Effects of Invention

According to various embodiments of the disclosure, it is possible to provide a device and a method for broadcasting a QoE configuration in a wireless communication system.

Advantageous effects obtainable from the disclosure may not be limited to the above-mentioned effects, and other effects which are not mentioned may be clearly understood from the following descriptions by those skilled in the art to which the disclosure pertains.

### BRIEF DESCRIPTION OF DRAWINGS

FIG. 1A illustrates a structure of a next-generation mobile communication system.

FIG. 1B illustrates wireless connection state transition in a next-generation mobile communication system;

FIG. 1C is a flowchart illustrating a procedure for configuring/reporting signaling-based quality of experience (QoE) measurement according to various embodiments of the disclosure;

FIG. 1D is a flowchart illustrating a procedure for configuring/reporting management-based quality of experience (QoE) measurement according to various embodiments of the disclosure;

FIG. 1E is a flowchart illustrating a transmission and reception procedure performed between a base station and a UE for supporting multicast/broadcast service (MBS) broadcast according to various embodiments of the disclosure;

FIG. 1F is a flowchart illustrating the operation of a UE for supporting MBS broadcast according to various embodiments of the disclosure;

FIG. 1G is a block diagram illustrating the internal structure of a UE according to various embodiments of the disclosure; and

FIG. 1H is a block diagram illustrating the configuration of a base station according to various embodiments of the disclosure.

### MODE FOR THE INVENTION

In describing the disclosure below, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In describing the embodiments in the specification, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

The following detailed description of embodiments of the disclosure is mainly directed to New RAN (NR) as a radio access network and Packet Core (5G system or 5G core network or next generation core (NG Core)) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the 5G system, a network data collection and analysis function (NWDAF), which is a network function for analyzing and providing data collected in a 5G network, may be defined to support network automation. The NWDAF may collect/store/analyze information from the 5G network and provide the results to unspecified network functions (NFs), and the analysis results may be used independently in each NF.

In the following description, some of terms and names defined in the 3GPP standards (standards for 5G, NR, LTE, or similar systems) may be used for the sake of descriptive convenience. However, the disclosure is not limited by these terms and names, and may be applied in the same way to systems that conform other standards.

In the following description, terms referring to signals, terms referring to channels, terms referring to control information, terms referring to network entities, terms referring to device elements, and the like are illustratively used for the sake of descriptive convenience. Therefore, the disclosure is not limited by the terms as used herein, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. However, they are merely examples thereof, and the base station and the terminal are not limited to these examples. In the disclosure, the term “eNB” may be interchangeably used with the term “gNB” for the sake of descriptive convenience. That is, a base station described as “eNB” may refer to “gNB”. In the disclosure, the term “terminal” may refer to not only mobile phones, NB-IoT devices, and sensors, but also various wireless communication devices.

In the following description, the terms “physical channel” and “signal” may be interchangeably used with the term “data” or “control signal”. For example, the term “physical downlink shared channel (PDSCH)” refers to a physical channel over which data is transmitted, but the PDSCH may also be used to refer to the “data”. That is, in the disclosure, the expression “transmit ting a physical channel” may be construed as having the same meaning as the expression “transmitting data or a signal over a physical channel”.

In the following description of the disclosure, upper signaling refers to a signal transfer scheme from a base station to a terminal via a downlink data channel of a physical layer, or from a terminal to a base station via an uplink data channel of a physical layer. The upper signaling may also be understood as radio resource control (RRC) signaling or a media access control (MAC) control element (CE).

Furthermore, as used in the disclosure, the expression “greater than” or “less than” is used to determine whether a specific condition is satisfied or fulfilled, but this is intended only to illustrate an example and does not exclude “greater than or equal to” or “equal to or less than”. A condition indicated by the expression “greater than or equal to” may be replaced with a condition indicated by “greater than”, a condition indicated by the expression “equal to or less than” may be replaced with a condition indicated by “less than”, and a condition indicated by “greater than and equal to or less than” may be replaced with a condition indicated by “greater than and less than”.

Furthermore, the embodiments of the disclosure will be described using terms employed in some communication standards (e.g., the 3rd generation partnership project (3GPP)), but they are for illustrative purposes only. The embodiments of the disclosure may be easily applied to other communication systems through modifications.

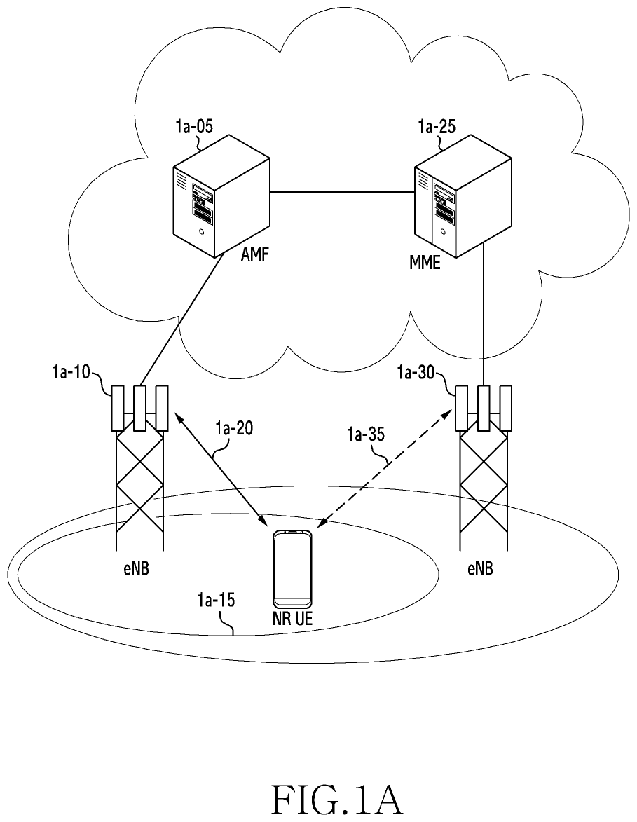

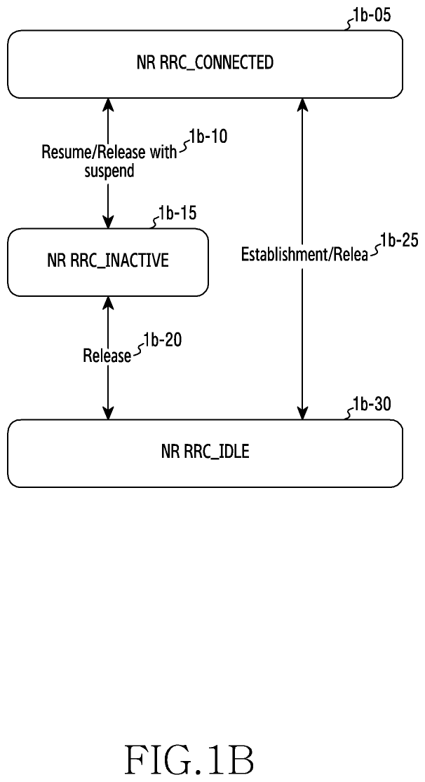

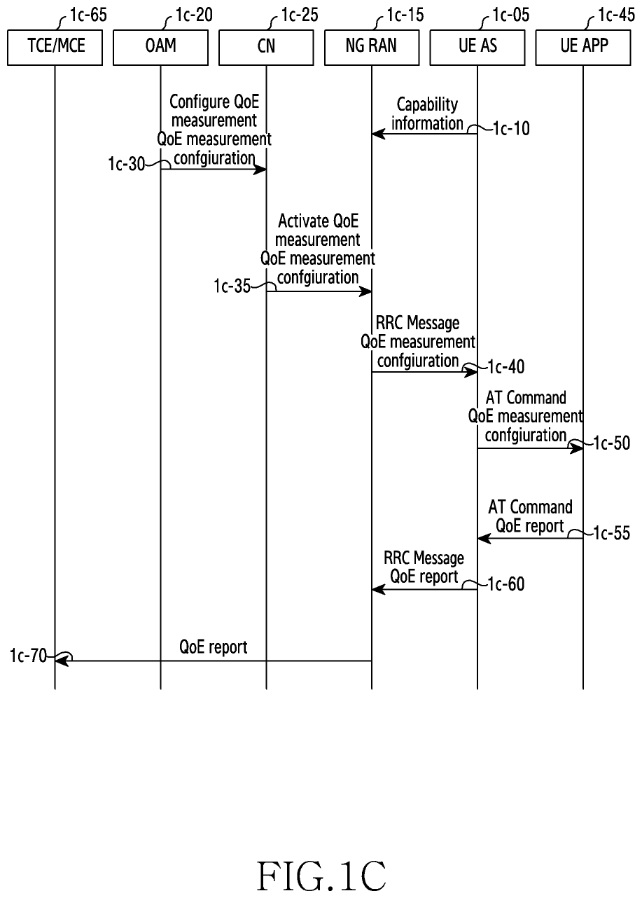

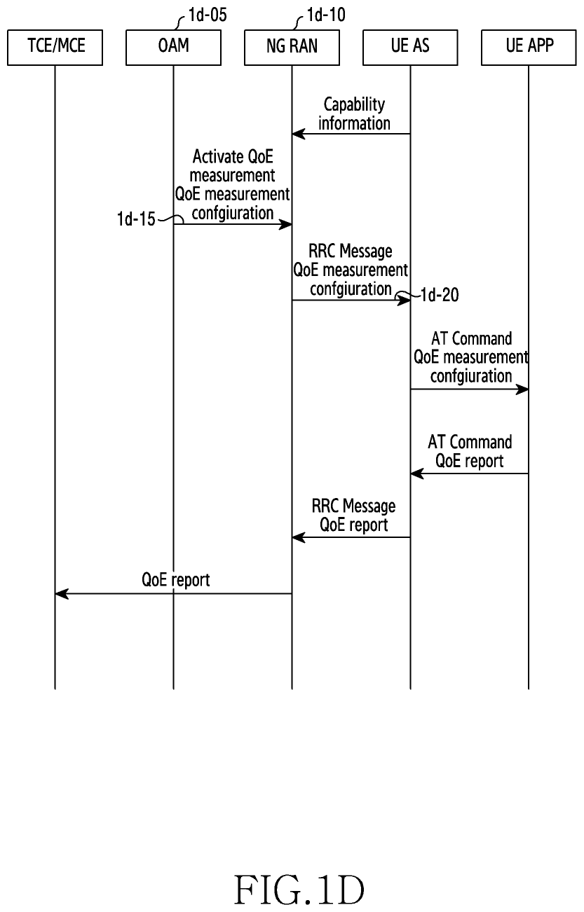

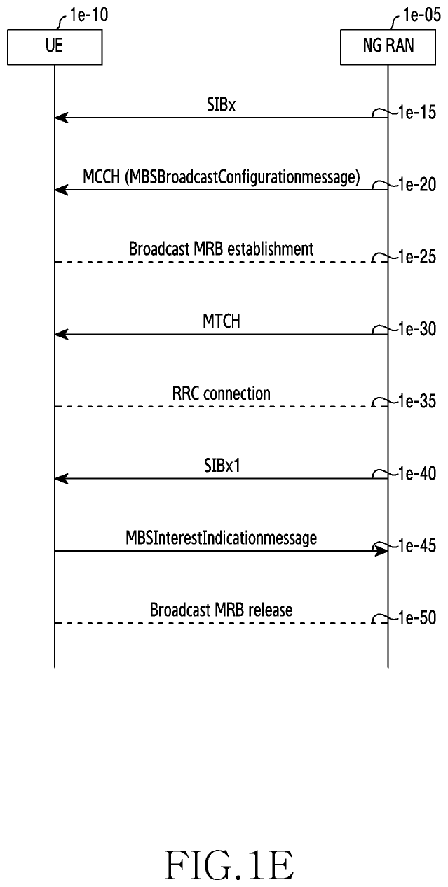

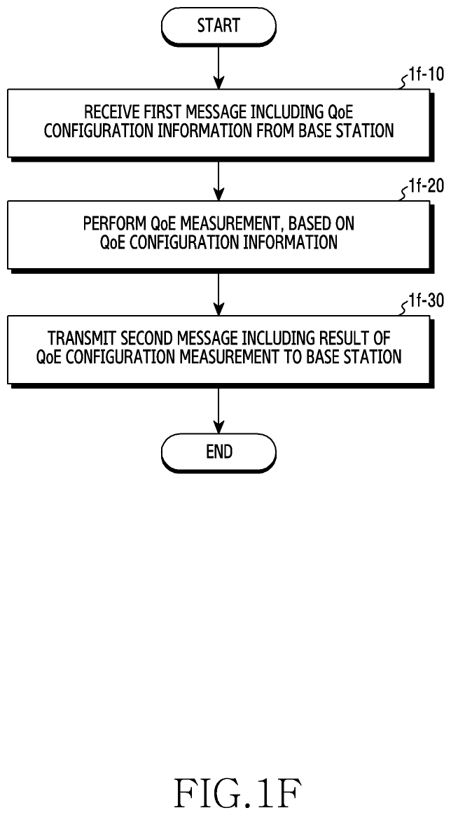

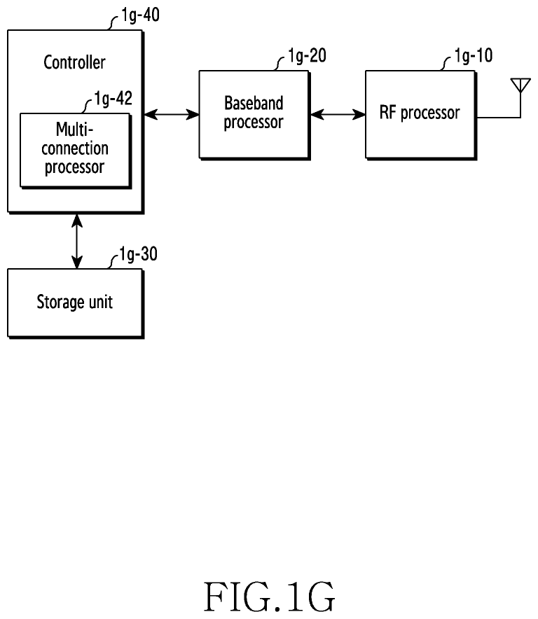

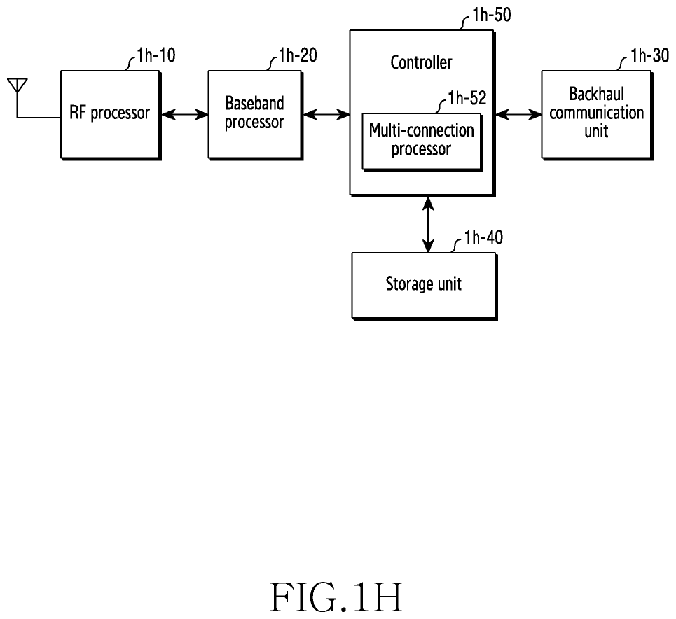

FIG. 1A illustrates a structure of a next-generation mobile communication system.

Referring to FIG. 1A, as illustrated therein, a radio access network of a next-generation mobile communication system (new radio, NR) may include a next-generation base station (new radio node B, hereinafter gNB) 1a-10 and an access and mobility management entity (AMF, new radio core network) 1a-05. A user terminal (new radio user equipment, hereinafter NR UE or NR terminal) 1c-15 may access an external network via the gNB 1a-10 and the AMF 1a-05.

In FIG. 1A, the gNB may correspond to an evolved node B (eNB) of a conventional LTE system. The gNB may be connected to the NR UE through a radio channel and provide outstanding services as compared to a conventional node B. In the next-generation mobile communication system, since all user traffic is serviced through a shared channel, a device that collects state information, such as buffer statuses, available transmit power states, and channel states of UEs, and performs scheduling accordingly may be required, and the gNB 1a-10 may be responsible for the operation of collecting and scheduling state information of UEs. In general, one gNB may control multiple cells. In order to implement ultrahigh-speed data transfer beyond the current LTE, the next-generation mobile communication system may provide a wider bandwidth than the existing maximum bandwidth, may employ an orthogonal frequency division multiplexing (hereinafter referred to as OFDM) as a radio access technology, and may additionally integrate a beamforming technology therewith. Furthermore, the next-generation mobile communication system may employ an adaptive modulation & coding (hereinafter referred to as AMC) scheme for determining a modulation scheme and a channel coding rate according to a channel state of a UE. The AMF 1a-05 may perform functions such as mobility support, bearer configuration, and QoS configuration. The AMF is a device responsible for various control functions as well as a mobility management function for a UE, and may be connected to multiple base stations. In addition, the next-generation mobile communication system may interwork with the existing LTE system, and the AMF may be connected to an MME 1a-25 via a network interface. The MME may be connected to an eNB 1a-30 that is an existing base station. A UE supporting LTE-NR dual connectivity may transmit/receive data while maintaining connections to both the gNB and the eNB.

FIG. 1B illustrates wireless connection state transition in a next-generation mobile communication system.

Referring to FIG. 1B, there are three wireless connection states (RRC states) in the next-generation mobile communication system. A connected mode (RRC_CONNECTED) 1b-05 may be a wireless connection state in which a UE is able to transmit and receive data. A standby mode (RRC_IDLE) 1b-30 may be a wireless connection state in which a UE monitors whether paging is transmitted to the UE. These two modes are wireless connection states also applied to the existing LTE system, and may have the same detailed technology as that in the existing LTE system. In the next-generation mobile communication system, a new inactive (RRC_INACTIVE) wireless connection state 1b-15 may be defined. In this wireless connection state, UE context is maintained in the base station and the UE, and RAN-based paging may be supported. The new wireless connection state may have characteristics listed below.
Cell re-selection mobility
CN-NR RAN connection (both C/U-planes) has been established for UE
The UE AS context is stored in at least one gNB and the UE
Paging is initiated by NR RAN
RAN-based notification area is managed by NR RAN
NR RAN knows the RAN-based notification area which the UE belongs to

The new inactive wireless connection state may transition to the connected mode or the standby mode by using a specific procedure. The inactive mode may be switched to the connected mode according to a resume procedure, and the connected mode may be switched to the inactive mode by using a release procedure including suspend configuration information (1b-10). In the foregoing procedure, one or more RRC messages may be transmitted and received between the UE and the base station, and one or more operations may be included. In addition, the inactive mode may be switched to the standby mode by using a release procedure after a resume procedure (1b-20). A switch between the connected mode and the standby mode may follow the existing LTE technology. That is, the switch between the modes may be performed through an establishment or release procedure (1b-25).

FIG. 1C is a flowchart illustrating a procedure for configuring/reporting signaling-based quality of experience (QoE) measurement according to various embodiments of the disclosure.

Referring to FIG. 1C, a UE access stratum (AS) 1c-05 may transmit information (e.g., qoe-MeasReport and qoe-MTSI-MeasReport) indicating whether QoE measurement is supported for each service type to a base station (or NG-RAN) 1c-15 through a UE capability message (1c-10). The UE capability message may include abstract syntax notation one (ASN.1) information in Table 1 and a description of a related parameter in Table 2.

TABLE 1

| | |
|---|---|
| MeasParameters-v1530 ::= | SEQUENCE { |
| qoe-MeasReport-r15 | ENUMERATED |

| | |
|---|---|
| {supported} | OPTIONAL, |

| | |
|---|---|
| qoe-MTSI-MeasReport-r15 | ENUMERATED |

| | |
|---|---|
| {supported} | OPTIONAL, |

| | |
|---|---|
| ca-IdleModeMeasurements-r15 | ENUMERATED |

| | |
|---|---|
| {supported} | OPTIONAL, |

| | |
|---|---|
| ca-IdleModeValidity Area-r15 | ENUMERATED |

| | |
|---|---|
| {supported} | OPTIONAL, |

| heightMeas-r15 | |
|---|---|
| ENUMERATED {supported} | OPTIONAL, |
| multipleCellsMeasExtension-r15 | ENUMERATED |

| | |
|---|---|
| {supported} | OPTIONAL |

}

```
TABLE 2
  qoe-MeasReport
  Indicates whether the UE supports QoE Measurement Collection for
streaming services.
  qoe-MTSI-MeasReport
  Indicates whether the UE supports QoE Measurement Collection for
MTSI services.
```

As illustrated above, as service types, LTE may support streaming and a multimedia telephony service for an IP multimedia subsystem (IMS) (MTSI), and NR may additionally support at least one of virtual reality (VR), multimedia broadcast multicast services (MBMS), and extended reality (XR).

An operations, administration, and maintenance (OAM) 1c-20 may provide QoE measurement configuration information to a core network (CN) 1c-25 (1c-30). Upon receiving QoE measurement configuration information, the CN may activate QoE measurement by transmitting the QoE measurement configuration information to the base station (1c-35). Upon receiving the QoE measurement configuration information, the base station may transmit the QoE measurement configuration information to the UE AS through an RRC message (e.g., an RRC connection reconfiguration message) (1c-40). The RRC message may include ASN.1 information in Table 3 and a description of a related parameter in Table 4.

TABLE 3

| | |
|---|---|
| measConfigAppLayer-r15 | CHOICE{ |

| | |
|---|---|
| release | NULL, |
| setup | SEQUENCE{ |

| | measConfigAppLayerContainer-r15 |
|---|---|
| OCTET STRING (SIZE(1..1000)), | |
| | serviceType-r15 |
| ENUMERATED {qoe, qoemtsi, spare6, spare5, spare4, spare3, spare2, | |
| spare1} | |
| | } |
| } | OPTIONAL, -- Need ON |

```
TABLE 4
  measConfigAppLayerContainer
  The field contains configuration of application layer measurements, see
Annex L (normative) in TS 26.247 [90] and clause 16.5 in TS 26.114 [99].
  serviceType
  Indicates the type of application layer measurement. Value qoe indicates
Quality of Experience Measurement Collection for streaming services, value
qoemtsi indicates Enhanced Quality of Experience Measurement Collection for
MTSI.
```

Upon receiving the RRC message, the UE AS may transmit the QoE measurement configuration information to a UE application layer (UE APP) 1c-45 through an AT command when the RRC message is a message for setting up a configuration (1c-50). When the RRC message is a message for releasing a configuration, the UE AS may transmit an AT command to delete stored configuration information to the UE APP. A specific operation of the UE AS receiving the RRC message may be as follows in Table 5.

TABLE 5

| | |
|---|---|
| 1> | if the received otherConfig includes the measConfigAppLayer: |
| 2> | if measConfigAppLayer is set to setup: |
| 3> | forward measConfigAppLayerContainer to upper |

layers considering the serviceType;

| | |
|---|---|
| 3> | consider itself to be configured to send application |

layer measurement report in accordance with 5.6.19;

| | |
|---|---|
| 2> | else: |
| 3> | inform upper layers to clear the stored application layer |

measurement configuration;

| | |
|---|---|
| 3> | discard received application layer measurement report |

information from upper layers;
3> consider itself not to be configured to send application layer measurement
report.

The UE APP may perform QoE measurement according to the received QoE measurement configuration information. In addition, the UE APP may report a QoE measurement result to the UE AS through an AT command according to the configuration information (1c-55). Upon receiving the QoE measurement result, the UE AS may report the QoE measurement result to the base station through an RRC message (e.g., a MeasReportAppLayer message) (1c-60). The UE AS may use signaling radio bearer (SRB) 4 to report the QoE measurement result. The RRC message may include ASN.1 information in Table 6 and a description of a related parameter in Table 7.

TABLE 6

| | |
|---|---|
| MeasReportAppLayer-r15 ::= | SEQUENCE { |
| criticalExtensions | CHOICE { |

measReportAppLayer-r15

MeasReportAppLayer-r15-IEs,

| | |
|---|---|
| criticalExtensionsFuture | SEQUENCE { } |

```
      }
    }
```

| | |
|---|---|
| MeasReportAppLayer-r15-IEs ::= | SEQUENCE { |
| measReportAppLayerContainer-r15 | OCTET STRING |

| | |
|---|---|
| (SIZE(1..8000)) | OPTIONAL, |

```
      serviceType-r15
  ENUMERATED {qoe, qoemtsi, spare6, spare5, spare4, spare3, spare2,
```

| | |
|---|---|
| spare1} | OPTIONAL, |

nonCriticalExtension

| | |
|---|---|
| MeasReportAppLayer-v1590-IEs | OPTIONAL |

}

TABLE 7

```
  measReportAppLayerContainer
  The field contains container of application layer measurements, see
Annex L (normative) in TS 26.247 [90] and clause 16.5 in TS 26.114 [99].
  serviceType
  Indicates the type of application layer measurement. Value qoe indicates
Quality of Experience Measurement Collection for streaming services, value
qoemtsi indicates Quality of Experience Measurement Collection for MTSI.
```

A specific procedure in which the UE AS procedure reports the QoE measurement result may be as follow in Table 8.

TABLE 8
A UE capable of application layer measurement reporting in RRC_CONNECTED
may initiate the procedure when configured with application layer measurement,
i.e. whenmeasConfigAppLayer has been configured by E-UTRAN.
Upon initiating the procedure, the UE shall:

| | |
|---|---|
| 1> | if configured with application layer measurement, and SRB4 is |

```
  configured, and the UE has received application layer measurement report
  information from upper layers:
```

| | |
|---|---|
| 2> | set the measReportAppLayerContainer in the MeasReportAppLayer |

```
    message to the value of the application layer measurement report
    information;
```

| | |
|---|---|
| 2> | set the serviceType in the MeasReportAppLayer message to the type |

```
    of the application layer measurement report information;
    2> submit the MeasReportAppLayer message to lower layers for
    transmission via SRB4.
```

The base station may forward a QoE measurement result report to a configured final destination (TCE or MCE 1c-65) (1c-70).

FIG. 1D is a flowchart illustrating a procedure for configuring/reporting management-based quality of experience (QoE) measurement according to various embodiments of the disclosure.

The management-based QoE configuration/report procedure may be similar to the foregoing signaling-based procedure (FIG. 1C). Therefore, only the differences of the management-based method are described herein, and other procedures and descriptions may be the same as those described in FIG. 1C. In the management-based method, an OAM 1d-05 may activate QoE measurement by directly transmitting a QoE measurement configuration to a base station 1d-10 without going through a CN (1d-15). Upon receiving the QoE measurement configuration, the base station retrieves a single UE or a plurality of UEs meeting a plurality of conditions (e.g., at least one of an area scope, an application layer capability, or a service type). The base station may transmit the QoE measurement configuration to each UE via an RRC message (e.g., an RRC connection reconfiguration message) (1d-20). Other procedures and message types may be considered to be the same as those described in FIG. 1C (signaling-based method).

FIG. 1E is a flowchart illustrating a transmission and reception procedure performed between a base station and a UE for supporting multicast/broadcast service (MBS) broadcast according to various embodiments of the disclosure.

Referring to FIG. 1E, in operation 1e-15, a UE 1e-10 in a standby mode (RRC_IDLE) or an inactive mode (RRC_INACTIVE) may camp on a cell or a base station 1e-05 providing SIBx, and may receive SIBx. A UE in a connected mode (RRC_CONNECTED) may also receive SIBx. SIBx may include information required for a UE to obtain MBS control channel (MCCH) information required for multicast/broadcast service (MBS) broadcast reception. An MCCH may have the following meaning: a point-to-multipoint downlink channel used for transmitting MBS broadcast control information associated with one or more MTCH(s) from a network to a UE. The ASN.1 format of SIBx may be as follows in Table 9. A description of a related parameter in Table 9 may be as follows in Table 10.

TABLE 9

| | |
|---|---|
| - | SIBx |

```
  SIBx contains the information required to acquire the MCCH
configuration for MBS broadcast.
  SIBx information element
```

| | |
|---|---|
| -- | ASN1START |
| -- | TAG-SIBX-START |

| | |
|---|---|
| SIBx-r17 ::= | SEQUENCE { |

| mcch-Config-r17 | MCCH-Config-r17, | |
|---|---|---|
| cfr-ConfigMCCH-MTCH-r17 | CFR-ConfigMCCH-MTCH-r17, | |
| lateNonCriticalExtension | OCTET STRING | OPTIONAL, |

...

```
  }
  MCCH-Config-r17 ::= SEQUENCE {
```

| | |
|---|---|
| mcch-RepetitionPeriodAndOffset-r17 | MCCH- |

RepetitionPeriodAndOffset-r17,

| | mcch-WindowStartSlot-r17 | INTEGER (0..79), |
|---|---|---|
| | mcch-WindowDuration-r17 | ENUMERATED |
| {sl2, sl4, sl8, sl10, sl20, sl40,sl80, sl160} | | OPTIONAL, -- NEED S |
| | mcch-ModificationPeriod-r17 | ENUMERATED {rf2, rf4, rf8, |

rf16, rf32, rf64, rf128, rf256,

rf512, rf1024, r2048, rf4096, rf8192, rf16384,

rf32768, rf65536}
}

| | |
|---|---|
| MCCH-RepetitionPeriodAndOffset-r17 ::= | CHOICE { |

| | |
|---|---|
| rf1-r17 | INTEGER(0), |
| rf2-r17 | INTEGER(0..1), |
| rf4-r17 | INTEGER(0..3), |
| rf8-r17 | INTEGER(0..7), |
| rf16-r17 | INTEGER(0..15), |
| rf32-r17 | INTEGER(0..31), |
| rf64-r17 | INTEGER(0..63), |
| rf128-r17 | INTEGER(0..127), |
| rf256-r17 | INTEGER(0..255) |

}

| | |
|---|---|
| -- | TAG-SIBX-STOP |
| -- | ASN1STOP |

```
  rf1024, r2048, rf4096, rf8192, rf16384, rf32768, rf65536}
  }
```

| | |
|---|---|
| MCCH-RepetitionPeriodAndOffset-r17 ::= | CHOICE { |

| | |
|---|---|
| rf1-r17 | INTEGER(0), |
| rf2-r17 | INTEGER(0..1), |
| rf4-r17 | INTEGER(0..3), |
| rf8-r17 | INTEGER(0..7), |
| rf16-r17 | INTEGER(0..15), |
| rf32-r17 | INTEGER(0..31), |
| rf64-r17 | INTEGER(0..63), |
| rf128-r17 | INTEGER(0..127), |
| rf256-r17 | INTEGER(0..255) |

```
  }
  -- TAG-SIBX-STOP
  -- ASN1STOP
```

TABLE 10
SIBx field descriptions

```
  mcch-WindowDuration
  Indicates, starting from the slot indicated by mcch-WindowStartSlot, the
duration in slot during which MCCH may be scheduled. Absence of this field
means that MCCH is only scheduled in the slot indicated by mcch-
WindowStartSlot.
  mcch-ModificationPeriod
  Defines periodically appearing boundaries, i.e. radio frames for which
SFN mod mcch-ModificationPeriod = 0. The contents of different transmissions of
MCCH information can only be different if there is at least one such boundary in-
between them. Value rf2 corresponds to two radio frames, value rf4 corresponds to
four radio frames and so on.
  mcch-RepetitionPeriodAndOffset
  Defines the length and the offset of the MCCH repetition period. rf1
corresponds to a repetition period length of one radio frame, rf2 corresponds to a
repetition period length of two radio frames and so on. The corresponding integer
value indicates the offset of the repetition period in the number of radio frames.
MCCH is scheduled in radio frames for which: SFN mod repetition period length =
offset of the repetition period.
  mcch-WindowStartSlot
  Indicates the slot in which MCCH transmission window starts.
```

In operation 1e-20, when wishing to receive (or interested in receiving) MBS broadcast, is receiving an MBS broadcast service, or receiving an MCCH information update notification after entering the cell providing SIBx, the UE supporting the MBS may obtain an MBSBroadcastConfiguration message on an MCCH, which may be described as follows in Table 11 in Rel-17 TS 38.331.

TABLE 11
5.X.2.3 MCCH information acquisition by the UE

An MBS capable UE interested to or receiving an MBS broadcast service

shall:

| | |
|---|---|
| 1> | if the procedure is triggered by an MCCH information change |

notification:

| 2> | start acquiring the MBSBroadcastConfiguration message on |
|---|---|
| MCCH from the slot in which the change notification was received; | |
| 1> | if the UE enters a cell broadcasting SIBx: |

| | |
|---|---|
| 2> | acquire the MBSBroadcastConfiguration message on MCCH at the next |

repetition period;

Update of MCCH information may be described as follows in Table 12 in Rel-17 TS 38.331.

TABLE 12
5.X.1.3 MCCH information validity and notification of changes

```
  Change of MCCH information only occurs at specific radio frames, i.e.
the concept of a modification period is used. Within a modification period, the
same MCCH information may be transmitted a number of times, as defined by its
scheduling (which is based on a repetition period).
  When the network changes (some of) the MCCH information, it notifies
the UEs about the change via PDCCH which schedules the MCCH in every
repetition period in the current modification period.
  Upon receiving a change notification, a UE receiving or interested to
receive MBS services transmitted using MBS broadcast acquires the new MCCH
information starting from the same slot. The UE applies the previously acquired
MCCH information until the UE acquires the new MCCH information. The
notification is transmitted with a 2-bit bitmap, see TS 38.212 [17] clause 7.3.1.2.1.
The MSB in the 2-bit bitmap, when set to ‘1’, indicates the start of MBS service(s).
The LSB in the 2-bit bitmap, when set to ‘1’, indicates modification of MCCH
information other than the change caused by start of new MBS service(s), e.g.
modification of a configuration of an on-going MBS session(s), MBS session(s)
stop or neighbouring cell information modification.
```

The ASN.1 format of the MBSBroadcastConfiguration message may be as follows in Table 13. A description of a related parameter in Table 13 may be as follows in Table 14.

TABLE 13
MBSBroadcastConfiguration message

```
    -- ASN1START
    -- TAG-MBSBROADCASTCONFIGURATION-START
```

| | |
|---|---|
| MBSBroadcastConfiguration-r17 ::= | SEQUENCE { |

| | |
|---|---|
| criticalExtensions | CHOICE { |

mbsBroadcastConfiguration-r17
MBSBroadcastConfiguration-r17-IEs,

| | |
|---|---|
| criticalExtensionsFuture | SEQUENCE { } |

```
        }
    }
```

| | |
|---|---|
| MBSBroadcastConfiguration-r17-IEs ::= | SEQUENCE { |

```
      mbs-SessionInfoList-r17 MBS-SessionInfoList-r17,
      mbs-NeighbourCellList-r17 MBS-NeighbourCellList-r17
          OPTIONAL, -- Need S
      drx-ConfigPTM-List-r17 SEQUENCE (SIZE
(1..maxNrofDRX-ConfigPTM-r17)) OF DRX-ConfigPTM-r17
  OPTIONAL, -- NEED R
```

| | |
|---|---|
| pdsch-ConfigMTCH-r17 | PDSCH-ConfigBroadcast-r17 |

OPTIONAL, -- Need S
mtch-SSB-MappingWindowList-r17 MTCH-SSB-
MappingWindowList-r17 OPTIONAL, -- Need R

| | | |
|---|---|---|
| lateNonCriticalExtension | OCTET STRING | OPTIONAL, |
| nonCriticalExtension | SEQUENCE { } | OPTIONAL |

```
    }
    -- TAG-MBSBROADCASTCONFIGURATION-STOP
-- ASN1STOP
```

TABLE 14
MBSBroadcastConfiguration field descriptions

```
  pdsch-ConfigMTCH
  Provides parameters for acquiring the PDSCH for MTCH. The UE shall
use parameters in pdsch-ConfigMCCH also for PDSCH of MTCH when this field
is absent.
  mbs-SessionInfoList
  Provides the configuration of each MBS session provided by MBS
broadcast in the current cell.
  mbs-NeighbourCellList
  List of neighbour cells providing MBS broadcast services via broadcast
MRB. This field is used by the UE together with mtch-NeighbourCell field
signalled for MBS session in the corresponding MBS-SessionInfo. When an
empty list is signalled, the UE shall assume that MBS broadcast services listed in
the MBSBroadcastConfiguration message are not provided via broadcast MRB in
any neighbour cell. When the field is absent, the current serving cell does not
provide information about MBS broadcast services in the neighbouring cells, i.e.
the UE cannot determine the presence or absence of an MBS service in
neighbouring cells based on the absence of this field.
```

The mbs-sessionInfoList parameter may include information about a plurality of MBS sessions currently served by the cell, and the ASN.1 format of the mbs-sessionInfoList parameter may be as follows in Table 15.

TABLE 15

| | |
|---|---|
| MBS-SessionInfoList-r17 ::= | SEQUENCE (SIZE |

(0..maxNrofMBS-Session-r17)) OF MBS-SessionInfo-r17

| | |
|---|---|
| MBS-SessionInfo-r17 ::= | SEQUENCE { |
| mbs-SessionId-r17 | TMGI-r17, |
| g-RNTI-r17 | RNTI-Value, |
| mrb-ListBroadcast-r17 | MRB-ListBroadcast-r17 |

OPTIONAL,

| | |
|---|---|
| mtch-SchedulingInfo-r17 | DRX-ConfigPTM-Index-r17 |

OPTIONAL, -- NEED S

| | |
|---|---|
| mtch-NeighbourCell-r17 | BIT STRING |

(SIZE(maxNeighCell-MBS-r17)) OPTIONAL,-- NEED R

| | |
|---|---|
| pdsch-ConfigIndex-r17 | PDSCH-ConfigIndex-r17 |

OPTIONAL, -- NEED S
mtch-SSB-MappingWindowIndex-r17 MTCH-SSB-
MappingWindowIndex-r17 OPTIONAL -- NEED R
}

In operation 1e-25, the UE may perform broadcast MBS radio bearer (MRB) establishment to receive an MBS broadcast session of interest. The broadcast MRB establishment may be started for the following reasons: upon starting the MBS session, upon entering a cell providing an MBS broadcast service the UE is interested in, upon becoming interested in the MBS broadcast service, upon removal of UE capability limitations inhibiting reception of the MBS broadcast service the UE is interested in.

In operation 1e-30, the UE may receive MBS broadcast data through an MBS traffic channel (MTCH). The MTCH may have the following meaning: a point-to-multipoint downlink channel for transmitting MBS data of either a multicast session or a broadcast session from the network to the UE. The UE may decode a physical downlink control channel (PDCCH) scrambled with a group RNTI (g-RNTI) to receive the MTCH. The g-RNTI needed to decode the PDCCH may be provided in the form of a single g-RNTI or a list of a plurality of g-RNTIs per MBS broadcast session (e.g., per mbs-SessionId or per temporary mobile group identity (TMGI)) through an MBS-SessionInfoList IE in the MBSBroadcastConfiguration message.

A procedure including operations 1e-25 and 1e-30 may be described as follows in Table 16 in Rel-17 TS 38.331.

TABLE 16
5.X.3.3 Broadcast MRB establishment

Upon a broadcast MRB establishment, the UE shall:

| | |
|---|---|
| 1> | establish a PDCP entity and an RLC entity in accordance with MRB- |

InfoBroadcast for this broadcast MRB included in the MBSBroadcastConfiguration
message and the configuration specified in 9.1.1.Y;

| | |
|---|---|
| 1> | receive DL-SCH on the cell where the MBSBroadcastConfiguration |

message was received for the MBS broadcast service for which the broadcast MRB
is established and using g-RNTI and mtch-SchedulingInfo (if included) in this
message for this MBS broadcast service;

| | |
|---|---|
| 1> | configure the physical layer in accordance with the mbs-SessionInfoList, |

searchSpaceMTCH, pdsch-ConfigMTCH, applicable for the broadcast MRB, as
included in the MBSBroadcastConfiguration message;

| | |
|---|---|
| 1> | inform upper layers about the establishment of the broadcast MRB by |

indicating the corresponding tmgi;

| | |
|---|---|
| 1> | if an SDAP entity with the received tmgi does not exist: |
| | 2> establish an SDAP entity as specified in TS 37.324 [24] clause 5.1.1. |

In operation 1e-35, the UE may transition to the connected mode by establishing an RRC connection with the base station. Alternatively, the UE may already be in the connected mode without the process of 1e-35.

In operation 1e-40, the UE may receive SIBx1. SIBx1 may include mapping of a frequency and an MBS service, and the ASN. 1 format may be as follows in Table 17. A description of a related parameter in Table 17 may be as follows in Table 18.

TABLE 17
SIBx1 information element

```
  -- ASN1START
  -- ASN1START
  -- TAG-SIBX1-START
  SIBx1-r17 ::= SEQUENCE {
```

| | |
|---|---|
| mbs-FSAI-IntraFreq-r17 | MBS-FSAI-List-r17 |

OPTIONAL, -- Need R

| | |
|---|---|
| mbs-FSAI-InterFreqList-r17 | MBS-FSAI-InterFreqList-r17 |

OPTIONAL, -- Need R

| | |
|---|---|
| lateNonCriticalExtension | OCTET STRING |

```
  OPTIONAL,
    ...
  }
```

| | |
|---|---|
| MBS-FSAI-List-r17 ::= | SEQUENCE (SIZE (1..maxFSAI- |

MBS-r17)) OF MBS-FSAI-r17

| | |
|---|---|
| MBS-FSAI-InterFreqList-r17 ::= | SEQUENCE (SIZE |

(1..maxFreq)) OF MBS-FSAI-InterFreq-r17
MBS-FSAI-InterFreq-r17 ::= SEQUENCE {

| | |
|---|---|
| dl-CarrierFreq-r17 | ARFCN-ValueNR, |
| mbs-FSAI-List-r17 | MBS-FSAI-List-r17 |

```
  }
  MBS-FSAI-r17 ::= OCTET STRING (SIZE (3))
  -- TAG-SIBX1-STOP
  -- ASN1STOP
```

TABLE 18
SIBx1 field descriptions

```
  mbs-FSAI-InterFreqList
  Contains a list of neighboring frequencies including additional bands, if
any, that provide MBS services and the corresponding MBS FSAIs.
  mbs-FSAI-IntraFreq
  Contains the list of MBS FSAIs for the current frequency. For MBS service
continuity, the UE shall use all MBS FSAIs listed in mbs-FSAI-IntraFreq to derive
the MBS frequencies of interest.
```

The presence of SIBx1 may implicitly enable reporting of the following MBSInterestIndication message to be reported. The absence of SIBx1 may implicitly disable reporting of the following MBSInterestIndication message. The order of operations 1e-35 and 1e-40 may be changed.

In operation 1e-45, the UE supporting the MBS in the connected mode may transmit the MBSInterestIndication message to report an MBS broadcast service that the UE is receiving or is interested in and a related frequency to the base station. Further, the UE supporting the MBS in the connected mode may transmit the MBSInterestIndication message to the base station to transmit priority information about MBS broadcast compared to unicast. The ASN.1 format of the MBSInterestIndication message may be as follows in Table 19. A description of a related parameter in Table 19 may be as follows in Table 20.

```
TABLE 19
MBSInterestIndication
  The MBSInterestIndication message is used to inform network that the
UE is receiving/ interested to receive or no longer receiving/ interested to
receive MBS broadcast service(s) via a broadcast MRB.
    Signalling radio bearer: SRB1
    RLC-SAP: AM
    Logical channel: DCCH
    Direction: UE to Network
MBSInterestIndication message
  -- ASN1START
  -- TAG-MBSINTERESTINDICATION-START
  MBSInterestIndication-r17 ::= SEQUENCE {
  criticalExtensions CHOICE {
```

| | |
|---|---|
| mbsInterestIndication-r17 | MBSInterestIndication-r17- |

IEs,

| | |
|---|---|
| criticalExtensionsFuture | SEQUENCE { } |

```
    }
  }
  MBSInterestIndication-r17-IEs ::= SEQUENCE {
```

| | |
|---|---|
| mbs-FreqList-r17 | CarrierFreqListMBS-r17 |

OPTIONAL,

| | |
|---|---|
| mbs-Priority-r17 | ENUMERATED {true} |

OPTIONAL,

| | |
|---|---|
| mbs-ServiceList-r17 | MBS-ServiceList-r17 |

```
OPTIONAL
  }
  -- TAG-MBSINTERESTINDICATION-STOP
-- ASN1STOP
```

TABLE 20
MBSInterestIndication field descriptions

```
  mbs-FreqList
  List of MBS frequencies on which the UE is receiving or interested to
receive MBS broadcast service via a broadcast MRB.
  mbs-Priority
  Indicates whether the UE prioritises MBS broadcast reception above unicast
and MBS multicast reception. The field is present (i.e. value true), if the UE
prioritises reception of all listed MBS frequencies above reception of any of the
unicast bearers. Otherwise the field is absent.
  mbs-ServiceList
  List of MBS broadcast services which the UE is receiving or interested to
receive.
```

The MBSInterestIndication message may be configured and transmitted the following procedure in Table 21.

In operation 1e-50, the UE may perform broadcast MRB release to stop receiving MBS broadcast. Alternatively, broadcast MRB release may be performed in the following cases: upon stop of the MBS session, upon leaving the cell broadcasting the MBS service the UE is interested in, upon losing interest in the MBS service, and when capability limitations start inhibiting reception of the concerned service.

A broadcast MRB release procedure may be described as follows in Table 22 in Rel-17 TS 38.331.

TABLE 22
5.X.3.4 Broadcast MRB release

Upon broadcast MRB release for MBS broadcast service, the UE shall:

| | |
|---|---|
| 1> | release the PDCP entity, RLC entity as well as the related |

MAC and physical layer configuration;

| | |
|---|---|
| 1> | inform upper layers about the release of the broadcast MRB |

by indicating the corresponding tmgi;

| | |
|---|---|
| 1> | if the SDAP entity associated with the corresponding tmgi |

has no associated MRB:

| | |
|---|---|
| 2> | release the SDAP entity, as specified in TS 37.324 [24] |

clause 5.1.2.

At a meeting for NR 3GPP standards, the RAN2 and RAN3 working groups have reached the following agreement on Release 17 (Rel-17).
(1) RAN3 agreements
(1-1) RAN3 #109e
(1-1-1) NR QOE management supports following types: Streaming/MTSI/VR/MBMS
(1-2) RAN3 #114e
(1-2-1) MBS and XR would not be supported in R17
(2) RAN2 agreements
(2-1) RAN2 #113e
(2-1-1) QoE measurements in RRC_IDLE/RRC_INACTIVE state can be supported, for MBS
(2-2) RAN2 #115e
(2-2-1) Confirm that RAN2 deprioritizes QoE measurement in RRC_IDLE/RRC_INACTIVE in Rel-17

That is, the working groups have agreed not to support QoE measurement for an MBS service in the standby mode (RRC_IDLE) or the inactive mode (RRC_INACTIVE) in Rel-17. Instead, that QoE measurement for an MBS service in the standby mode (RRC_IDLE) or the inactive mode (RRC_INACTIVE) is supported in Rel-18 (for at least MBS broadcast, undecided for MBS multicast) is included as follows in the Rel-18 work item description (WID).
(1) Rel-18 WID
(1-2) Specify for QoE measurement configuration and collection in RRC_INACTIVE and RRC_IDLE states for MBS, at least for broadcast service. [RAN3, RAN2]

The reason why MBS technology has been introduced into 3GPP standard technologies is that a base station may repeatedly transmit dedicated data to each UE, in which the base station requires a large quantity of processing, computing technologies, and resources for data transmission and radio resource scheduling and repeated data transmission may cause considerable radio resource usage and energy consumption. Likewise, a method in which a base station repeatedly transmits a QoE configuration to each UE through a dedicated RRC message (e.g., an RRCReconfiguration or RRCResume message) may also be inefficient. Further, since UEs in the inactive and standby modes as well as in the connected mode may receive MBS broadcast and perform QoE measurement, switching the UEs one by one to the connected mode for QoE measurement configuration may be a huge burden on the base station. Instead, a broadcast message (e.g., a system information message, an MCCH) may be used to simultaneously transmit QoE configuration information of the same information to a plurality of UEs. The MBSBroadcastConfiguration message transmitted on the MCCH in 1e-20 may be used for MBS broadcast, and according to an embodiment of the disclosure, the MBSBroadcastConfiguration message may include QoE configuration information about MBS broadcast or/and multicast services. The UE may receive the MBSBroadcastConfiguration message regardless of an RRC mode. Therefore, the base station may forward QoE measurement configuration information to the UEs receiving the MBS (broadcast or/and multicast) services through the MBSBroadcastConfiguration message.

In an embodiment of the disclosure, the QoE configuration information (e.g., AppLayerMeasConfig) in the MBSBroadcastConfiguration message may be as follows in Table 23. A description of a related parameter in Table 23 may be as follows in Table 24.

TABLE 23
MBSBroadcastConfiguration message

```
  -- ASN1START
  -- TAG-MBSBROADCASTCONFIGURATION-START
```

| | |
|---|---|
| MBSBroadcastConfiguration-r17 ::= | SEQUENCE { |

| | |
|---|---|
| criticalExtensions | CHOICE { |

mbsBroadcastConfiguration-r17
MBSBroadcastConfiguration-r17-IEs,

| | |
|---|---|
| criticalExtensionsFuture | SEQUENCE { } |

```
      }
  }
```

| | |
|---|---|
| MBSBroadcastConfiguration-r17-IEs ::= | SEQUENCE { |

```
    mbs-SessionInfoList-r17 MBS-SessionInfoList-r17,
      appLayerMeasConfig AppLayerMeasConfig
OPTIONAL,
    mbs-NeighbourCellList-r17 MBS-NeighbourCellList-r17
        OPTIONAL, -- Need S
    drx-ConfigPTM-List-r17 SEQUENCE (SIZE (1..maxNrofDRX-
```

| | |
|---|---|
| ConfigPTM-r17)) OF DRX-ConfigPTM-r17 | OPTIONAL, -- |

NEED R

| | |
|---|---|
| pdsch-ConfigMTCH-r17 | PDSCH- |
| | ConfigBroadcast-r17 |

OPTIONAL, -- Need S

| | |
|---|---|
| mtch-SSB-MappingWindowList-r17 | MTCH-SSB- |

```
MappingWindowList-r17
  OPTIONAL, -- Need R
  lateNonCriticalExtension OCTET STRING OPTIONAL,
  nonCriticalExtension SEQUENCE { } OPTIONAL
  }
  -- TAG-MBSBROADCASTCONFIGURATION-STOP
-- ASN1STOP
```

TABLE 24
MBSBroadcastConfiguration field descriptions

```
  appLayerMeasConfig
  Provides application layer measurement configuration for MBS broadcast
  pdsch-ConfigMTCH
  Provides parameters for acquiring the PDSCH for MTCH. The UE shall
use parameters in pdsch-ConfigMCCH also for PDSCH of MTCH when this field
is absent.
  mbs-SessionInfoList
  Provides the configuration of each MBS session provided by MBS
broadcast in the current cell.
  mbs-NeighbourCellList
  List of neighbour cells providing MBS broadcast services via broadcast
MRB. This field is used by the UE together with mtch-NeighbourCell field signalled
for MBS session in the corresponding MBS-SessionInfo. When an empty list is
signalled, the UE shall assume that MBS broadcast services listed in the
MBSBroadcastConfiguration message are not provided via broadcast MRB in any
neighbour cell. When the field is absent, the current serving cell does not provide
information about MBS broadcast services in the neighbouring cells, i.e. the UE
cannot determine the presence or absence of an MBS service in neighbouring cells
based on the absence of this field.
```

AppLayerMeasConfig may have the following ASN.1 format illustrated in Table 25. A description of a related parameter in Table 25 may be as follows in Table 26.

TABLE 25
AppLayerMeasConfig information element

```
  -- ASN1START
  -- TAG-APPLAYERMEASCONFIG-START
```

| | |
|---|---|
| AppLayerMeasConfig-r17 ::= | SEQUENCE { |

| | |
|---|---|
| measConfigAppLayerToAddModList-r17 | SEQUENCE |

(SIZE (1..maxNrofAppLayerMeas-r17)) OF MeasConfigAppLayer-r17
OPTIONAL, -- Need N

| | |
|---|---|
| measConfigAppLayerToReleaseList-r17 | SEQUENCE |

(SIZE (1..maxNrofAppLayerMeas-r17)) OF MeasConfigAppLayerId-r17
OPTIONAL, -- Need N

| | |
|---|---|
| rrc-SegAllowed-r17 | ENUMERATED |
| | {enabled} |

```
OPTIONAL, -- Need M
    ...
  }
  MeasConfigAppLayer-r17 ::= SEQUENCE {
```

| | |
|---|---|
| measConfigAppLayerId-r17 | MeasConfigAppLayerId-r17, |

measConfigAppLayerContainer-r17 OCTET STRING (SIZE

| | |
|---|---|
| (1..8000)) | OPTIONAL, -- Need N |

| | |
|---|---|
| serviceType-r17 | ENUMERATED |

{streaming, mtsi, vr, spare5, spare4, spare3, spare2, spare1}
OPTIONAL, -- Need M

| | |
|---|---|
| pauseReporting | BOOLEAN, |

transmissionOfSessionStartStop BOOLEAN,

| | |
|---|---|
| ran-VisibleParameters-r17 | SetupRelease |

| | |
|---|---|
| {RAN-VisibleParameters-r17} | OPTIONAL, -- Need M |

```
    ...
  }
  RAN-VisibleParameters-r17 ::= SEQUENCE {
```

| | |
|---|---|
| ran-VisiblePeriodicity | ENUMERATED {ms120, |
| ms240, ms480, ms640, ms1024} | OPTIONAL, -- Need S |

| | |
|---|---|
| numberOfBufferLevelEntries | INTEGER |
| | (1..8) |

```
OPTIONAL, -- Need R
  reportInitialPlayOutDelay BOOLEAN,
    ...
  }
  -- TAG-APPLAYERMEASCONFIG-STOP
-- ASN1STOP
```

TABLE 26
AppLayerMeasConfig field descriptions

```
  measConfigAppLayerContainer
  The field contains configuration of application layer measurements, see
Annex L (normative) in TS 26.247 [XX], clause 16.5 in TS 26.114 [YY] and TS
26.118 [ZZ].
  numberOfBufferLevelEntries
  The field contains the maximum number of buffer level entries that can
be reported for RAN visible application layer measurements.
  pauseReporting
  The field indicates whether the transmission of
measurementReportAppLayerContainer is paused or not.
  ran-VisiblePeriodicity
  The field indicates the periodicity of RAN visible reporting. Value ms 120
indicates 120 ms, value ms 240 indicates 240 ms and so on. If no value is indicated
and the UE is configured with RAN visible reporting, the same periodicity as
indicated in the measConfigAppLayerContainer is used.
  reportInitialPlayoutDelay
  The field indicates whether the UE shall report Initial Playout Delay for
RAN visible application layer measurements.
  rrc-SegAllowed
  This field, when received in MeasConfigAappLayerMeasConfigList,
indicates that RRC segmentation of MeasurementReportAppLayer is allowed. It
may be present only if the UE supports RRC message segmentation.
  serviceType
  Indicates the type of application layer measurement. Value streaming
indicates Quality of Experience Measurement Collection for streaming services
(see [XX]), value mtsi indicates Quality of Experience Measurement Collection
for MTSI (see [YY]). value vr indicates Quality of Experience Measurement
Collection for VR service (see [ZZ]). The network always configures serviceType
when application layer measurements are initially configured and at fullConfig.
  transmissionOfSessionStartStop
  The field indicates whether the UE shall transmit indications when
sessions in the application layer start and stop. The UE transmits a session start
indication upon configuration of this field if a session already has started in the
application layer.
```

In an embodiment of the disclosure, MBSBroadcastConfiguration-r17-IEs may not include AppLayerMeasConfig as a subparameter, but may include some or all parameters in AppLayerMeasConfig as subparameters.

In an embodiment of the disclosure, AppLayerMeasConfig may be included for each entry (e.g., MBS-SessionInfo) in MBS-SessionInfoList as follows in Table 27. That is, the base station may provide different QoE configuration information to the UE for each MBS session. A description of a related parameter in Table 27 may be as follows in Table 28.

TABLE 27
MBS-SessionInfoList information element

```
    -- ASN1START
    -- TAG-MBS-SESSIONINFOLIST-START
```

| | |
|---|---|
| MBS-SessionInfoList-r17 ::= | SEQUENCE (SIZE (0..maxNrofMBS- |

Session-r17)) OF MBS-SessionInfo-r17

| | |
|---|---|
| MBS-SessionInfo-r17 ::= | SEQUENCE { |
| mbs-SessionId-r17 | TMGI-r17, |
| appLayerMeasConfig | AppLayerMeasConfig |

OPTIONAL,

| | |
|---|---|
| g-RNTI-r17 | RNTI-Value, |

| | |
|---|---|
| mrb-ListBroadcast-r17 | MRB-ListBroadcast-r17 |

OPTIONAL,

| | |
|---|---|
| mtch-SchedulingInfo-r17 | DRX-ConfigPTM-Index-r17 |

OPTIONAL, -- NEED S

| | |
|---|---|
| mtch-NeighbourCell-r17 | BIT STRING (SIZE(maxNeighCell- |

MBS-r17)) OPTIONAL, -- NEED R

| | |
|---|---|
| pdsch-ConfigIndex-r17 | PDSCH-ConfigIndex-r17 |

OPTIONAL, -- NEED S

| | |
|---|---|
| mtch-SSB-MappingWindowIndex-r17 | MTCH-SSB- |

| | |
|---|---|
| MappingWindowIndex-r17 | OPTIONAL -- NEED R |

}

| | |
|---|---|
| DRX-ConfigPTM-Index-r17 ::= | INTEGER (0..maxNrofDRX- |

ConfigPTM-1-r17)

| | |
|---|---|
| PDSCH-ConfigIndex-r17 ::= | INTEGER (0..maxNrofPDSCH- |

ConfigPTM-1-r17)

| | | |
|---|---|---|
| MTCH-SSB-MappingWindowIndex-r17 | ::= | INTEGER |

(0..maxNrofMTCH-SSB-MappingWindow-1-r17)

| | |
|---|---|
| MRB-ListBroadcast-r17 ::= | SEQUENCE (SIZE (1..maxNrofMRB- |

Broadcast-r17)) OF MRB-InfoBroadcast-r17

| | |
|---|---|
| MRB-InfoBroadcast-r17 ::= | SEQUENCE { |

| | |
|---|---|
| pdcp-Config-r17 | MRB-PDCP-ConfigBroadcast-r17, |
| rlc-Config-r17 | MRB-RLC-ConfigBroadcast-r17, |

```
      ...
    }
```

| | |
|---|---|
| MRB-PDCP-ConfigBroadcast-r17 ::= | SEQUENCE { |

| | |
|---|---|
| pdcp-SN-SizeDL-r17 | ENUMERATED {len12bits} |

| | |
|---|---|
| OPTIONAL, | -- NEED S |

| | |
|---|---|
| headerCompression-r17 | CHOICE { |

| | |
|---|---|
| notUsed-r17 | NULL, |
| rohc-r17 | SEQUENCE { |

| | | |
|---|---|---|
| maxCID-r17 | INTEGER (1..16383) | DEFAULT |

15,

| | |
|---|---|
| profiles-r17 | SEQUENCE { |
| profile0x0001-r17 | BOOLEAN, |
| profile0x0002-r17 | BOOLEAN, |
| profile0x0003-r17 | BOOLEAN |

```
            }
          }
```

| | |
|---|---|
| } OPTIONAL | , -- NEED R |

| | |
|---|---|
| t-Reordering-r17 | ENUMERATED {ms1, ms10, ms40, |

ms160, ms500, ms1000, ms1250, ms2750} OPTIONAL -- Need S
}

| | |
|---|---|
| MRB-RLC-ConfigBroadcast-r17 ::= | SEQUENCE { |

| | |
|---|---|
| logicalChannelIdentity-r17 | logicalChannelIdentity, |
| sn-FieldLength-r17 | ENUMERATED {size6} |

OPTIONAL, -- NEED S

| | |
|---|---|
| t-Reassembly-r17 | T-Reassembly |

```
  OPTIONAL -- NEED S
    }
```

| | |
|---|---|
| TMGI-r17 ::= | SEQUENCE { |
| plmn-Id-r17 | CHOICE { |
| plmn-Index-r17 | INTEGER (1..maxPLMN), |
| explicitValue-r17 | PLMN-Identity |

},

| | |
|---|---|
| serviceId-r17 | OCTET STRING (SIZE (3)) |

```
    }
    -- TAG-MBS-SESSIONINFOLIST-STOP
-- ASN1STOP
```

TABLE 28
MBS-SessionInfoList field descriptions

```
  appLayerMeasConfig
  Provides application layer measurement configuration for MBS broadcast
  g-RNTI
  G-RNTI used to scramble the scheduling and transmission of MTCH.
  headerCompression
  If rohc is configured, the UE shall apply the configured ROHC profile(s)
in downlink. When the field is absent the UE applies the value as specified in
9.1.1.Y.
  mbsSessionId
  Indicates an identifier of the MBS session provided by the MTCH.
  mrb-listBroadcast
  A list of broadcast MRBs to which the associated broadcast MBS session
is mapped to.
  mtch-neighbourCell
  Indicates neighbour cells which provide this service on MTCH. The first
bit is set to 1 if the service is provided on MTCH in the first cell in mbs-
NeighbourCellList, otherwise it is set to 0. The second bit is set to 1 if the service
is provided on MTCH in the second cell in mbs-NeighbourCellList, and so on. If
the service is not available in any neighbouring cell and mbs-NeighbourCellList
is signalled, the network sets all bits in this field to 0. If this field is absent, the
related service may or may not be available in any neighbouring cell, i.e. the UE
cannot determine the presence or absence
  of an MBS service in neighbouring cells based on the absence of this field.
  mtch-schedulingInfo
  Indicates the index of DRX configuration entry in drx-ConfigPTM-List
that is used for scheduling the MTCH. The value 0 corresponds to the first entry in
drx-ConfigPTM-List, the value 1 corresponds to the second entry in drx-
ConfigPTM-List and so on. In case mtch-schedulingInfo is absent for a G-RNTI
(i.e. no PTM DRX), the UE shall monitor for PDCCH scrambled with G-RNTI in
any slot according to the search space configured for MTCH [see TS 38.213 [13],
clause 10.1].
  mtch-SSB-MappingWindowIndex
  Indicates the index of MTCH-SSB-MappingWindowCycleOffset
configuration entry in MTCH-SSB-MappingWindowList. The value 0 corresponds
to the first entry in MTCH-SSB-MappingWindowList, the value 1 corresponds to
the second entry in MTCH-SSB-MappingWindowList and so on. This field is set to
the same value for all MBS sessions mapped to the same G-RNTI.
  pdcp-SN-SizeDL
  Indicates that PDCP sequence number size of 12 bits is used, as specified
in TS 38.323 [5]. When the field is absent the UE applies the value as specified in
9.1.1.Y.
  pdschConfigIndex
  Indicates the index of PDSCH configuration entry in pdschConfigList for
MTCH. Value 0 corresponds to the first entry in pdschConfigList, the value 1
corresponds to the second entry in pdschConfigList and so on. When the field
  is absent the UE applies the first entry in pdschConfigList for MTCH.
  sn-FieldLength
  Indicates that the RLC SN field size of 6 bits is used, see TS 38.322 [4].
When the field is absent the UE applies the value as specified in 9.1.1.Y.
  t-Reassembly
  Timer for reassembly in TS 38.322 [4], in milliseconds. Value ms 0 means
0 ms, value ms 5 means 5 ms and so on. When the field is absent the UE applies the
value in specified in 9.1.1.Y.
  t-Reordering
  Value in ms of t-Reordering specified in TS 38.323 [5]. Value ms 1
corresponds to 1 ms, value ms 10 corresponds to 10 ms, and so on. When the field
is absent the UE applies the value as specified in 9.1.1.Y.
```

In an embodiment of the disclosure, each entry (e.g., MBS-SessionInfo) in MBS-SessionInfoList may not include AppLayerMeasConfig as a subparameter, but may include some or all parameters in AppLayerMeasConfig as subparameters.

In the foregoing embodiments, the QoE configuration information and the related parameters may be as follows.
The QoE configuration information (e.g., AppLayerMeasConfig) may indicate addition of a plurality of pieces of QoE configuration information (e.g., MeasConfigAppLayer) (e.g., measConfigAppLayerToAddModList). The QoE configuration information (e.g., AppLayerMeasConfig) may indicate release (or deletion) of a plurality of pieces of QoE configuration information (e.g., MeasConfigAppLayer) (e.g., measConfigAppLayerToReleaseList).
Alternatively, the QoE configuration information (e.g., AppLayerMeasConfig) may indicate addition of only single QoE configuration information (e.g., MeasConfigAppLayer). The QoE configuration information (e.g., AppLayerMeasConfig) may indicate release (or deletion) of only single QoE configuration information (e.g., MeasConfigAppLayer).
The base station may configure an rrc-segAllowed parameter dedicated to a UE reporting a capability to support uplink (UL) RRC segmentation (for a QoE measurement report message or MeasurementReportAppLayer), thereby allowing uplink (UL) RRC segmentation (for a QoE measurement report message or MeasurementReportAppLayer) to the UE. Alternatively, in an embodiment of the disclosure, the rrc-segAllowed parameter may be commonly applied to a plurality of UEs, and each UE may have different capabilities. (For example, UE A is able to support UL RRC segmentation, but UE B may not support UL RRC segmentation.) Therefore, when the UE in the disclosure supports UL RRC segmentation, the UE may determine whether to perform UL RRC segmentation according to the rrc-segAllowed parameter. In this case, the UE may not need to report the capability. However, when the UE does not support UL RRC segmentation, the UE may ignore the rrc-segAllowed parameter, or may not perform UL RRC segmentation. A description of an rrc-segAllowed field may be as follows in Table 29.

TABLE 29
rrc-SegAllowed

This field, when received in AppLayerMeasConfig, indicates that RRC
segmentation of MeasurementReportAppLayer is allowed. (Delete: It may be
present only if the UE supports RRC message segmentation.) UE who does not
support RRC message segmentation ignores this field.

The base station may configure measConfigAppLayerId as an ID for indicating each QoE configuration (e.g., MeasConfigAppLayer). Since a QoE configuration (e.g., MeasConfigAppLayer) may be configured dedicated to each UE, measConfigAppLayerId may also be configured and allocated for each UE. For example, the base station may transmit a QoE configuration with measConfigAppLayerId=1 to UE A and transmit a QoE configuration with measConfigAppLayerId=1 to UE B, and the two QoE configurations may be completely different or unrelated. However, when a QoE configuration is broadcast as in the disclosure, a QoE configuration ID may also be shared by the plurality of UEs. Therefore, instead of measConfigAppLayerId, a new ID (e.g., measConfigAppLayerID-Mbs) for the broadcast QoE configuration may be additionally defined in the QoE configuration (e.g., MeasConfigAppLayer) and shared with the UEs receiving an MBS service. For example, the base station may broadcast a QoE configuration with measConfigAppLayerId-Mbs of 1, and UE A and UE B may receive the QoE configuration with measConfigAppLayerId-Mbs of 1, and may use measConfigAppLayerId-Mbs and the QoE configuration in common.
In an embodiment, measConfigAppLayerContainer may include UE-specific (or dedicated) APPlayer QoE measurement configuration information. In an embodiment, the APPlayer QoE measurement configuration information (e.g., measConfigAppLayerContainer) may include APP-layer QoE measurement configuration information common to the plurality of UEs receiving the MBS service.
In an embodiment, serviceType specifies a service type to which APP-layer QoE measurement is applied, and the base station may configure serviceType to a streaming service, an MTSI service, or a VR service. In an embodiment, for the MBS service, an MBS service may be additionally defined as serviceType. Alternatively, MBS broadcast and MBS multicast services may be defined separately.
In an embodiment, the base station may temporarily pause (by configuring pauseReporting to true) or resume (by configuring pauseReporting to false) QoE reporting (report generated by the corresponding configuration) of the UE through a pauseReporting indication. In an embodiment, the base station may temporarily pause or resume QoE reporting commonly to the plurality of UE through the indication.
In an embodiment, when pauseReporting is true, instead of all UEs having received pauseReporting stopping QoE reporting, only a UE satisfying some or all of the following conditions may stop QoE reporting.
1. When the number of QoE reports or the size of data recently transmitted by the UE to the base station for a certain time (T1) is a specific threshold or longer
2. When the UE supports pause and resume
3. When the UE determines that a QoE measurement result is good for a certain time (T2) (e.g., when a service delay is shorter than a certain threshold, when a playout delay is shorter than a certain threshold, when an initial playout delay is shorter than a certain threshold, or when an application buffer level is a certain threshold or longer, and is enough for a seamless service)
4. When there has recently been QoE measurement result reporting for a certain time (T3)

T1, T2, T3, or the foregoing thresholds may be values configured by the base station broadcasting the same through an MBSBroadcastConfiguration message or system information. Alternatively, T1, T2, T3, or the thresholds may be values that the base station may configure for each UE through a dedicated message. Alternatively, T1, T2, T3, or the thresholds may be fixed values defined in the standards.
5. When the UE supports the MBS
6. When the UE supports QoE measurement
7. When the UE is receiving an MBS service corresponding to received pauseReporting
8. When the UE is performing QoE measurement for the MBS service corresponding to received pauseReporting
9. When the UE is receiving an MBS session corresponding to received pauseReporting
10. When the UE is performing QoE measurement in the MBS session corresponding to received pauseReporting
In an embodiment, transmissionOfSessionStartStop may indicate whether the UE needs to report to the base station that a session stars or stops in the APP layer when the session starts or stops in the APP layer. In an embodiment, the base station may commonly indicate whether a UE needs to report to the base station that a session starts to or stops when the session starts or stops to all UE by using an indication (e.g., transmissionOfSessionStartStop).
In an embodiment, separately from transmissionOfSessionStartStop, an indication (e.g., transmissionOfMbsSessionStartStop) may be additionally defined to indicate whether each UE needs to report to the base station whether the UE starts or stops receiving an MBS session or service or an MTCH when the UE starts or stops receiving the MBS session or service or the MTCH. Alternatively, when serviceType in the QoE configuration information is MBS or the QoE configuration information is forwarded through a broadcast message (e.g., MBSBroadcastConfiguration or system information), transmissionOfSessionStartStop may be used as an indication. When the indication is true, each UE may need to report to the base station that the UE starts or stops receiving an MBS session or service or an MTCH when the UE starts or stops receiving the MBS session or service or the MTCH. When the indication is false, each UE may not report to the base station that the UE starts or stops receiving an MBS session or service or an MTCH when the UE starts or stops receiving the MBS session or service or the MTCH.
ran-VisibleParameters may include a configuration for RAN visible QoE (e.g., reporting a QoE measurement result visible to the base station). The indication (e.g., ran-VisibleParameters) may be used for the plurality of UEs receiving the MBS service.

When the QoE configuration information is broadcasted, the plurality of UES may be configured at once, but too many UEs may transmit a QoE measurement report to the base station, and thus the base station may be overloaded. Therefore, instead of all UEs having received the QoE configuration information, only a UE satisfying a specific condition may perform QoE measurement reporting. Only a UE satisfying some or all of the following conditions may perform QoE measurement reporting.
1. When the number of QoE reports or the size of data recently transmitted by the UE to the base station for a certain time (T1) is a specific threshold or less
2. When the UE supports QoE measurement and reporting
3. When the UE determines that a QoE measurement result is bad for a certain time (T2) (e.g., when a service delay is longer than a certain threshold, when a playout delay is longer than a certain threshold, when an initial playout delay is longer than a certain threshold, or when an application buffer level is a certain threshold or less, and is not enough for a seamless service)
4. When there has recently been no QoE measurement result reporting for a certain time (T3)
5. When receiving a corresponding MBS session or service or MTCH for at least a certain time (T4) or longer

T1, T2, T3, T4 or the foregoing thresholds may be values configured by the base station broadcasting the same through an MBSBroadcastConfiguration message or system information. Alternatively, T1, T2, T3, T4, or the thresholds may be values that the base station may configure for each UE through a dedicated message. Alternatively, T1, T2, T3, T4, or the thresholds may be fixed values defined in the standards.
6. When the UE supports the MBS
7. When the UE supports QoE measurement
8. When the UE is receiving the corresponding MBS service
9. When the UE is performing QoE measurement for the corresponding MBS service
10. When the UE is receiving the corresponding MBS session
11. When the UE is performing QoE measurement in the MBS session

In the disclosure, the UE receiving the MTCH in 1e-30 may perform QoE measurement. The UE in the inactive or standby mode may store a QoE measurement result instead of immediately transmitting the QoE measurement result. The UE in the inactive or standby mode may transition to the connected mode to report the QoE measurement result (e.g., when a certain quantity of QoE reports is accumulated). To transition to the connected mode, a new cause value (e.g., at least one of ResumeCause, EstablishmentCause, or ReestablishmentCause) may be defined to indicate the reason for transitioning to the connected mode. Alternatively, the UE may notify the base station that there is the QoE measurement result, and the base station may collect a QoE measurement result report after establishing an RRC connection to the UE. When the UE transitions to the connected mode (1e-35) or when the UE is initially in the connected mode, the UE may report a stored or measured QoE result to the base station (1c-60). Here, the UE may transmit a QoE result report via SRB4 by using a MeasurementReportAppLayer message as follows in Table 30. A description of a related parameter in Table 30 may be as follows in Table 31.

TABLE 30
MeasurementReportAppLayer message

```
  -- ASN1START
  -- TAG-MEASUREMENTREPORTAPPLAYER-START
  MeasurementReportAppLayer-r17 ::= SEQUENCE {
```

| | |
|---|---|
| criticalExtensions | CHOICE { |

| | |
|---|---|
| measurementReportAppLayerList-r17 | SEQUENCE (SIZE |

(1..maxNrofAppLayerMeas-r17)) OF MeasurementReportAppLayer-r17-IEs,

| | |
|---|---|
| criticalExtensionsFuture | SEQUENCE { } |

```
    }
  }
  MeasurementReportAppLayer-r17-IEs ::= SEQUENCE {
```

| | |
|---|---|
| measConfigAppLayerId-r17 | MeasConfigAppLayerId-r17, |

measurementReportAppLayerContainer-r17 OCTET STRING
OPTIONAL,

| | |
|---|---|
| applicationLayerSessionStatus-r17 | ENUMERATED {started, |

| | |
|---|---|
| stopped} | OPTIONAL, |

| | |
|---|---|
| ran-VisibleMeasurements-r17 | RAN- |

| | |
|---|---|
| VisibleMeasurements-r17 | OPTIONAL, |

| | |
|---|---|
| lateNonCriticalExtension | OCTET STRING |

OPTIONAL,

| | |
|---|---|
| nonCriticalExtension | SEQUENCE{ } |

```
OPTIONAL
  }
  RAN-VisibleMeasurements-r17 ::= SEQUENCE {
    applicationLayerBufferLevelList-r17 SEQUENCE (SIZE (1..8)) OF
```

| | |
|---|---|
| ApplicationLayerBufferLevel | OPTIONAL, |

| | |
|---|---|
| initialPlayoutDelay-r17 | INTEGER (0..30000) |

OPTIONAL,

| | |
|---|---|
| pdu-SessionIdList-r17 | SEQUENCE (SIZE (1..maxNrofPDU- |
| Sessions-r17)) OF PDU-SessionID | OPTIONAL, |

```
    ...
  }
```

| | |
|---|---|
| ApplicationLayerBufferLevel ::= | INTEGER (0..30000) |

-- TAG-MEASUREMENTREPORTAPPLAYER-STOP
-- ASN1STOP

TABLE 31
MeasurementReportAppLayer field descriptions

```
  applicationLayerBufferLevel
  Indicates the application layer buffer level in ms. Value 1 corresponds to
10 ms, value 2 corresponds to 20 ms and so on. If the buffer level is larger than the
maximum value of 30000 (5 minutes), the UE reports 30000.
  applicationLayerSessionStatus
  Indicates that a QoE session in the application layer starts or stops.
  initialPlayoutDelay
  Indicates the application layer initial playout delay in ms. Value 1
corresponds to 1 ms, value 2 corresponds to 2 ms and so on. If the intial playout delay
is larger than the maximum value of 30000 ms, the UE reports 30000 ms.
  measurementReportAppLayerContainer
  The field contains application layer measurements, see Annex L (normative)
in TS 26.247 [XX], clause 16.5 in TS 26.114 [YY] and TS 26.118 [ZZ].
  pdu-SessionIdList
  Contains the identity of the PDU session, or the identities of the PDU
sessions, used for application data flows subject to the RAN visible application layer
measurements.
```

In an embodiment of the disclosure, the UE may report the QoE measurement result (e.g., measurementReportAppLayerList) through the MBSInterestIndication message (1e-45) as follows in Table 32. A description of a related parameter in Table 32 may be as follows in Table 33.

TABLE 32
MBSInterestIndication message

```
  -- ASN1START
  -- TAG-MBSINTERESTINDICATION-START
  MBSInterestIndication-r17 ::= SEQUENCE {
  criticalExtensions CHOICE {
```

| | |
|---|---|
| mbsInterestIndication-r17 | MBSInterestIndication-r17- |

IEs,

| | |
|---|---|
| criticalExtensionsFuture | SEQUENCE { } |

```
    }
  }
  MBSInterestIndication-r17-IEs ::= SEQUENCE {
```

| | |
|---|---|
| mbs-FreqList-r17 | CarrierFreqListMBS-r17 |

OPTIONAL,

| | |
|---|---|
| mbs-Priority-r17 | ENUMERATED {true} |

```
OPTIONAL,
      mbs-ServiceList-r17 MBS-ServiceList-r17 OPTIONAL
      measurementReportAppLayerList SEQUENCE (SIZE
(1..maxNrofAppLayerMeas-r17)) OF
MeasurementReportAppLayer-r17-IEs
  OPTIONAL
  }
  -- TAG-MBSINTERESTINDICATION-STOP
  -- ASN1STOP
```

TABLE 33
MBSInterestIndication field descriptions

```
  mbs-FreqList
  List of MBS frequencies on which the UE is receiving or interested to receive
MBS broadcast service via a broadcast MRB.
  mbs-Priority
  Indicates whether the UE prioritises MBS broadcast reception above unicast
and MBS multicast reception. The field is present (i.e. value true), if the UE prioritises
reception of all listed MBS frequencies above reception of any of the unicast bearers.
Otherwise the field is absent.
  mbs-ServiceList
  List of MBS broadcast services which the UE is receiving or interested to
receive.
  measurementReportAppLayerList
  Includes application layer measurement report for MBS broadcast
```

That is, a plurality of QoE reports (e.g., MeasurementReportAppLayer-r17-IEs) may be included in a single MBSInterestIndication message. Alternatively, an MBSInterestIndication message may be defined to include only a single QoE report (e.g., MeasurementReportAppLayer-r17-IEs). The foregoing parameter is an optional field, and the UE may transmit the parameter by including the same in MBSInterestIndication only when there is a QoE report not yet transmitted. Alternatively, the UE may transmit the parameter by including the same in MBSInterestIndication only when the base station allows transmission of a QoE report, and the base station may transmit an indication indicating permission for transmission of a QoE report (e.g., appLayerMeasReportAllowed) to the UE through a broadcast message (e.g., MBSBroadcastConfiguration or SIB) or a dedicated message (e.g., RRCReconfiguration or RRCResume).

In an embodiment of the disclosure, as shown in Table 34, each entry (i.e., MBS-ServiceInfo) in MBS-ServiceList in the MBSInterestIndication message may be defined to include a plurality of MeasurementReportAppLayer-r17-IEs or a single MeasurementReportAppLayer-r17-IEs. Here, a TMGI value in MBS-ServiceInfo may indicate which MBS-session the QoE report is generated by. This embodiment may be applied when the base station provides different QoE configuration information to the UE in each MBS session.

TABLE 34
MBS-ServiceList information element

```
    -- ASN1START
    -- TAG-MBSSERVICELIST-START
```

| | |
|---|---|
| MBS-ServiceList-r17 ::= | SEQUENCE (SIZE |

(0..maxNrofMBS-ServiceListPerUE-r17)) OF MBS-ServiceInfo-r17

| | |
|---|---|
| MBS-ServiceInfo-r17 ::= | SEQUENCE { |
| tmgi-r17 | TMGI-r17 |

| | |
|---|---|
| measurementReportAppLayerList | SEQUENCE (SIZE |

(1..maxNrofAppLayerMeas-r17)) OF
MeasurementReportAppLayer-r17-IEs
OPTIONAL
}
-- TAG-MBSSERVICELIST-STOP
-- ASN1STOP

The foregoing parameter is an optional field, and may be included in MBS-ServiceInfo and transmitted in MBSInterestIndication only when there is a QoE report for a corresponding TMGI (i.e., an MBS session). Alternatively, the parameter may be included in MBSInterestIndication and transmitted only when the base station allows transmission of a QoE report, and to allow transmission of a QoE report, the base station may transmit a predetermined indication for allowing transmission of a QoE report (e.g., appLayerMeasReportAllowed) to the UE through a broadcast message (e.g., MBSBroadcastConfiguration or SIB) or a dedicated message (e.g., RRCReconfiguration or RRCResume).

MBSInterestIndication may be transmitted via SRB1. In an embodiment of the disclosure, when a QoE measurement result report (e.g., measurementReportAppLayerList) is included in an MBSInterestIndication message, the MBSInterestIndication message may be reported via SRB4 (lower in priority than SRB1). However, when the QoE measurement result report is not included in the MBSInterestIndication message, the MBSInterestIndication message may be reported via SRB1. In an embodiment of the disclosure, the MBSInterestIndication message may always be transmitted via SRB1 regardless of the presence or absence of the QoE measurement result report.

In the foregoing embodiments, all or some parameters of MeasurementReportAppLayer-r17-IEs may be included for QoE reporting, or a new parameter may be included as follows.
The UE may configure measConfigAppLayerId indicating a specific QoE configuration ID to indicate which QoE configuration each QoE report (e.g., MeasurementReportAppLayer-r17-IEs) is generated by.
When a new ID (e.g., measConfigAppLayerID-Mbs) for broadcast QoE configuration is additionally defined and indicated in a QoE configuration (e.g., MeasConfigAppLayer), the new ID (e.g., measConfigAppLayerID-Mbs) may be defined and included in each QoE report (e.g., MeasurementReportAppLayer-r17-IEs). That is, the UE may indicate which broadcast QoE configuration the QoE report is generated by through the indication.
The UE may include a QoE measurement result report (measurementReportAppLayerContainer-r17) of the APP layer.
When the base station configures transmissionOfSessionStartStop to true when configuring QoE, the UE may configure applicationLayerSessionStatus to “started” when a session starts in the APP layer, and configure applicationLayerSessionStatus to “stopped” when the session stops.
In an embodiment of the disclosure, when transmissionOfMbsSessionStartStop is configured to true in QoE configuration, the UE may configure a new indication (e.g., applicationLayerMbsSessionStatus) to “started” when starting to receive an MBS session or service or an MTCH, and configure the indication “stopped” when stopping receiving the MBS session or service or the MTCH. In an embodiment, when serviceType is an MBS or QoE configuration information is forwarded via a broadcast message (e.g., MBSBroadcastConfiguration or system information), applicationLayerSessionStatus may be used as the indication.
An RAN-visible QoE report for an MBS service may be transmitted via a ran-VisibleMeasurements parameter.

The disclosure may be applied when serviceType is an MBS or MBS broadcast.

Although the disclosure mainly illustrates a method using MBSBroadcastConfiguration for transmitting QoE configuration information, a method using a system information message (SIB) may be applied in the same or similar manner. Alternatively, a method for configuring QoE measurement by defining a new message in an MCCH may also be applied in the same or similar manner. Alternatively, a method of transmitting QoE configuration information for an MBS through a dedicated message (e.g., an RRCReconfiguration message or RRCResume message) may also be applied in the same or similar manner.

FIG. 1F is a flowchart illustrating the operation of a UE for supporting MBS broadcast according to various embodiments of the disclosure.

Referring to FIG. 1F, a procedure for a UE supporting an MBS to receive a configuration for QoE measurement and to report a QoE measurement result according to the foregoing embodiments may be described.

In operation 1f-10, when wishing to receive (or interested in receiving) MBS broadcast, is receiving an MBS broadcast service, or receiving an MCCH information update notification after entering a cell providing SIBx, the UE supporting the MBS may obtain an MBSBroadcastConfiguration message including QoE configuration information on an MCCH from a base station. An mbs-sessionInfoList parameter may include information about a plurality of MBS sessions currently served by the cell.

In operation 1f-20, the UE receiving the MTCH from the base station may perform QoE measurement. The UE in the inactive or standby mode may store a QoE measurement result instead of immediately transmitting the QoE measurement result. The UE in the inactive or standby mode may transition to the connected mode to report the QoE measurement result (e.g., when a certain quantity of QoE reports is accumulated). To transition to the connected mode, a new cause value (e.g., at least one of ResumeCause, EstablishmentCause, or ReestablishmentCause) may be defined to indicate the reason for transitioning to the connected mode. Alternatively, the UE may notify the base station that there is the QoE measurement result, and the base station may collect a QoE measurement result report after establishing an RRC connection to the UE. The UE may transition to the connected mode.

In operation 1f-30, the UE supporting the MBS in the connected mode may transmit an MBSInterestIndication message to report an MBS broadcast service that the UE is receiving or is interested in and a related frequency to the base station. Further, the UE supporting the MBS in the connected mode may transmit the MBSInterestIndication message to transmit priority information about the MBS broadcast compared to unicast. Here the MBSInterestIndication message may include the QoE measurement result in operation 1f-20.

FIG. 1G is a block diagram illustrating the internal structure of a UE according to various embodiments of the disclosure.

Referring to FIG. 1G, the UE may include a radio frequency (RF) processor 1g-10, a baseband processor 1g-20, a storage unit 1g-30, and a controller 1g-40.

The RF processor 1g-10 may perform a function for transmitting or receiving a signal through a wireless channel, such as band conversion and amplification of a signal. That is, the RF processor 1g-10 may upconvert a baseband signal, provided from the baseband processor 1g-20, into an RF band signal to transmit the RF band signal through an antenna, and may downconvert an RF band signal, received through the antenna, into a baseband signal. For example, the RF processor 1g-10 may include a transmission filter, a reception filter, an amplifier, a mixer, an oscillator, a digital-to-analog converter (DAC), an analog-to-digital converter (ADC), and the like. Although the drawing shows only one antenna, the UE may include a plurality of antennas. In addition, the RF processor 1g-10 may include a plurality of RF chains. Further, the RF processor 1g-10 may perform beamforming. For beamforming, the RF processor 1g-10 may adjust the phase and strength of each of signals transmitted and received through a plurality of antennas or antenna elements. The RF processor may perform MIMO, and may receive a plurality of layers when performing MIMO.

The baseband processor 1g-20 may perform a function of converting a baseband signal and a bit stream according to the physical-layer specification of a system. For example, in data transmission, the baseband processor 1g-20 may encode and modulate a transmission bit stream, thereby generating complex symbols. In data reception, the baseband processor 1g-20 may demodulate and decode a baseband signal, provided from the RF processor 1g-10, thereby reconstructing a reception bit stream. For example, according to orthogonal frequency-division multiplexing (OFDM), in data transmission, the baseband processor 1g-20 may generate complex symbols by encoding and modulating a transmission bit stream, may map the complex symbols to subcarriers, and may construct OFDM symbols through an inverse fast Fourier transform (IFFT) and cyclic prefix (CP) insertion. In data reception, the baseband processor 1g-20 may divide a baseband signal, provided from the RF processor 1g-10, into OFDM symbols, may reconstruct signals mapped to subcarriers through a fast Fourier transform (FFT), and may reconstruct a reception bit stream through demodulation and decoding.

As described above, the baseband processor 1g-20 and the RF processor 1g-10 may transmit and receive signals. Accordingly, the baseband processor 1g-20 and the RF processor 1g-10 may be referred to as a transmitter, a receiver, a transceiver, or a communication unit. At least one of the baseband processor 1g-20 and the RF processor 1g-10 may include a plurality of communication modules to support a plurality of different radio access technologies. Further, at least one of the baseband processor 1g-20 and the RF processor 1g-10 may include different communication modules for processing signals in different frequency bands. For example, the different radio access technologies may include a wireless LAN (e.g., IEEE 802.11), a cellular network (e.g., LTE or NR), and the like. In addition, the different frequency bands may include a super high frequency (SHF) band (e.g., 2.NRHz, NRhz) and a millimeter wave band (e.g., 60 GHz).

The storage unit 1g-30 may store data, such as a default program, an application, and configuration information for operating the UE. In particular, the storage unit 1g-30 may store information related to a second access node performing wireless communication using a second radio access technology. The storage unit 1g-30 may provide stored data upon request from the controller 1g-40.

The controller 1g-40 may control overall operations of the UE. For example, the controller 1g-40 may transmit and receive signals through the baseband processor 1g-20 and the RF processor 1g-10. Further, the controller 1g-40 records and reads data in the storage unit 1g-30. To this end, the controller 1g-40 may include at least one processor. For example, the controller 1g-40 may include a communication processor (CP) to perform control for communication and an application processor (AP) to control an upper layer, such as an application.

FIG. 1H is a block diagram illustrating the configuration of a base station according to various embodiments of the disclosure.

Referring to FIG. 1H, the base station may include an RF processor 1h-10, a baseband processor 1h-20, a backhaul communication unit 1h-30, a storage unit 1h-40, and a controller 1h-50.

The RF processor 1h-10 may perform a function for transmitting or receiving a signal through a wireless channel, such as band conversion and amplification of a signal. That is, the RF processor 1h-10 may upconvert a baseband signal, provided from the baseband processor 1h-20, into an RF band signal to transmit the RF band signal through an antenna, and may downconvert an RF band signal, received through the antenna, into a baseband signal. For example, the RF processor 1h-10 may include a transmission filter, a reception filter, an amplifier, a mixer, an oscillator, a DAC, an ADC, and the like. Although the drawing shows only one antenna, the first access node may include a plurality of antennas. In addition, the RF processor 1h-10 may include a plurality of RF chains. Further, the RF processor 1h-10 may perform beamforming. For beamforming, the RF processor 1h-10 may adjust the phase and strength of each of signals transmitted and received through a plurality of antennas or antenna elements. The RF processor may transmit one or more layers, thereby performing downlink MIMO.

The baseband processor 1h-20 may perform a function of converting a baseband signal and a bit stream according to the physical-layer specification of a first radio access technology. For example, in data transmission, the baseband processor 1h-20 may encode and modulate a transmission bit stream, thereby generating complex symbols. In data reception, the baseband processor 1h-20 may demodulate and decode a baseband signal, provided from the RF processor 1h-10, thereby reconstructing a reception bit stream. For example, according to OFDM, in data transmission, the baseband processor 1h-20 may generate complex symbols by encoding and modulating a transmission bit stream, may map the complex symbols to subcarriers, and may construct OFDM symbols through an IFFT and CP insertion. In data reception, the baseband processor 1h-20 may divide a baseband signal, provided from the RF processor 1h-10, into OFDM symbols, may reconstruct signals mapped to subcarriers through an FFT, and may reconstruct a reception bit stream through demodulation and decoding. As described above, the baseband processor 1h-20 and the RF processor 1h-10 may transmit and receive signals. Accordingly, the baseband processor 1h-20 and the RF processor 1h-10 may be referred to as a transmitter, a receiver, a transceiver, a communication unit, or a wireless communication unit.

The backhaul communication unit 1h-30 may provide an interface for performing communication with other nodes in a network. That is, the backhaul communication unit 1h-30 may convert a bit stream, transmitted from the main base station to another node, for example, a secondary base station or a core network, into a physical signal, and may convert a physical signal, received from the other node, into a bit stream.

The storage unit 1h-40 may store data, such as a default program, an application, and configuration information for operating the base station. In particular, the storage unit 1h-40 may store information on a bearer allocated to a connected UE, a measurement result reported from a connected UE, and the like. The storage unit 1h-40 may store information as a criterion for determining whether to provide or stop a multi-connection for the UE. The storage unit 1h-40 may provide stored data upon request from the controller 1h-50.

The controller 1h-50 may control overall operations of the main base station. For example, the controller 1h-50 may transmit and receive signals through the baseband processor 1h-20 and the RF processor 1h-10 or through the backhaul communication unit 1h-30. Further, the controller 1h-50 records and reads data in the storage unit 1h-40. To this end, the controller 1h-50 may include at least one processor.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a terminal in a wireless communication system, the method comprising:
receiving, from a base station, a first message including quality of experience (QoE) configuration information;
performing a QoE measurement, based on the QoE configuration information; and
transmitting, to the base station, a second message including a result of the QoE measurement,
wherein the first message is broadcast from the base station.

2. The method of claim 1, wherein the first message include an MBSBroadcastConfiguration message, and the second message include an MBSInterestIndication message.

3. The method of claim 1, wherein the first message further includes information on a multicast/broadcast service (MBS) broadcast session,
wherein each of the MBS broadcast session includes a different QoE configuration information, and
wherein the second message includes a result of a QoE measurement for at least one MBS broadcast session.

4. The method of claim 1, wherein the first message includes at least one of radio resource control (RRC) segmentation allowance information, a broadcast identifier, a QoE configuration information identifier, or information for triggering a report of the result, and
wherein the information for triggering the report of the result includes at least one of a threshold for a QoE measurement value or a threshold for minimum time require to receive an MBS service.

5. A method performed by a base station in a wireless communication system, the method comprising:
transmitting, to a terminal, a first message including quality of experience configuration (QoE) information; and
receiving, from the terminal, a second message including a result of a QoE measurement,
wherein the first message is broadcast, and the QoE measurement is based on the QoE configuration information.

6. The method of claim 5, wherein the first message include an MBSBroadcastConfiguration message, and the second message include an MBSInterestIndication message.

7. The method of claim 5, wherein the first message further includes information on a multicast/broadcast service (MBS) broadcast session,
wherein each of the MBS broadcast session includes a different QoE configuration information, and
wherein the second message includes a result of a QoE measurement for at least one MBS broadcast session.

8. The method of claim 5, wherein the first message includes at least one of radio resource control (RRC) segmentation allowance information, a broadcast identifier, a QoE configuration information identifier, or information for triggering a report of the result, and
wherein the information for triggering the report of the result includes at least one of a threshold for a QoE measurement value or a threshold for minimum time require to receive an MBS service.

9. A terminal in a wireless communication system, the terminal comprising:
a transceiver; and
at least one processor coupled with the transceiver and configured to:
receive, from a base station, a first message including quality of experience (QoE) configuration information,
perform a QoE measurement, based on the QoE configuration information, and
transmit, to the base station, a second message including a result of the QoE measurement,
wherein the first message is broadcast from the base station.

10. The terminal of claim 9, wherein the first message include an MBSBroadcastConfiguration message, and the second message include an MBSInterestIndication message.

11. The terminal of claim 9, wherein the first message further includes information on a multicast/broadcast service (MBS) broadcast session,
wherein each of the MBS broadcast session includes a different QoE configuration information, and
wherein the second message includes a result of a QoE measurement for at least one MBS broadcast session.

12. The terminal of claim 9, wherein the first message includes at least one of radio resource control (RRC) segmentation allowance information, a broadcast identifier, a QoE configuration information identifier, or information for triggering a report of the result, and
wherein the information for triggering the report of the result includes at least one of a threshold for a QoE measurement value or a threshold for minimum time require to receive an MBS service.

13. A base station in a wireless communication system, the base station comprising:
a transceiver; and
at least one processor coupled with the transceiver and configured to:
transmit, to a terminal, a first message including quality of experience configuration (QoE) information, and
receive, from the terminal, a second message including a result of a QoE measurement,
wherein the first message is broadcast, and the QoE measurement is based on the QoE configuration information.

14. The base station of claim 13, wherein the first message include an MBSBroadcastConfiguration message, and the second message include an MBSInterestIndication message.

15. The base station of claim 13, wherein the first message further includes information on a multicast/broadcast service (MBS) broadcast session,
wherein each of the MBS broadcast session includes a different QoE configuration information, and
wherein the second message includes a result of a QoE measurement for at least one MBS broadcast session.
